(19) United States
(12) Patent Application Publication
(10) Pub. No.: US 2015/0334526 A1
(43) Pub. Date: Nov. 19, 2015

(54) USING A WIRELESS DEVICE NAME AS A BASIS FOR CONTENT SELECTION

(71) Applicant: International Business Machines Corporation, Armonk, NY (US)

(72) Inventors: Steven C. Jacobson, Mebane, NC (US); Loc X. Nguyen, Raleigh, NC (US); Luke D. Remis, Raleigh, NC (US); Timothy R. Tennant, Durham, NC (US)

(73) Assignee: International Business Machines Corporation, Armonk, NY (US)

(21) Appl. No.: 14/279,387

(22) Filed: May 16, 2014

(51) Int. Cl. H04W 4/02; H04W 48/16; H04W 4/00; H04W 76/02; G06Q 30/02; H04B 1/713

(52) U.S. Cl. CPC H04W 4/023; G06Q 30/0261; H04B 1/713; H04W 4/008; H04W 76/02; H04W 48/16

(57) ABSTRACT

A method includes a wireless mobile communication device discovering a proximate wireless audio device, receiving a device name from the wireless audio device, and providing the device name to a content server. The method further includes the content server analyzing the device name to identify a location or activity, selecting content relevant to the identified location or activity, and providing the selected content to the wireless mobile communication device. Optionally, the location or activity may be a kitchen, garage or other room of a residence or a conference room or break room of a business. The selected content is preferably relevant to the location or activity, such as an advertisement for tools or lawn equipment responsive to the identified location being the garage.

### BACKGROUND

1. Field of the Invention

The present invention relates to methods of selecting content to be delivered to an electronic device.

2. Background of the Related Art

Wireless mobile communication devices, such as mobile phones and wireless enabled tablet computers, provide a user with access to content and services anywhere that the wireless network has coverage. For example, a user may use an app or web browser to request the delivery of specific content or access a particular service. Such content and services may be available over a global communication network that is accessible to a mobile device through a wireless communication network.

However, sometimes is it desirable to make a user aware of content or services that is relevant to their current location or activity. For example, targeted advertising attempts to provide a user of a mobile communication device with an advertisement that is relevant to that user's interests and needs. For example, if user is at the beach, it is reasonable that the user might be more interested in content regarding sunscreen than content regarding hardware.

### BRIEF SUMMARY

One embodiment of the present invention provides a method comprising a wireless mobile communication device discovering a proximate wireless audio device, receiving a device name from the wireless audio device, and providing the device name to a content server. The method further comprises the content server analyzing the device name to identify a location or activity, selecting content relevant to the identified location or activity, and providing the selected content to the wireless mobile communication device.

### BRIEF DESCRIPTION OF THE SEVERAL VIEWS OF THE DRAWINGS

FIG. 1 is a diagram of a system for providing location-based content to a wireless mobile communication device.

FIG. 2 is a diagram of a wireless mobile communication device.

FIG. 3 is a diagram of a content server for providing location-based content.

FIG. 4 is a diagram of a display screen of a wireless mobile communication device upon discovering a wireless audio device.

FIG. 5 is a diagram of a wireless mobile communication device receiving and displaying selected content.

FIG. 6 is a flowchart of a method according to one embodiment of the present invention.

### DETAILED DESCRIPTION

One embodiment of the present invention provides a method comprising a wireless mobile communication device discovering a proximate wireless audio device, receiving a device name from the wireless audio device, and providing the device name to a content server. The method further comprises the content server analyzing the device name to identify a location or activity, selecting content relevant to the identified location or activity, and providing the selected content to the wireless mobile communication device.

The wireless communication device may be, without limitation, a mobile phone or a wireless enabled computer regardless of its form of implementation. For example, a modern tablet computer may be equipped with built-in wireless communication capabilities such that the tablet computer can be used anywhere.

A wireless audio device typically includes a speaker, an amplifier for driving the speaker, and an antenna for receiving a wireless communication. The wireless communication may include commands or instructions, identification or vital product data, or a streaming audio signal. A discovery process allows a mobile communication device to detect the presence of a wireless audio device and identify that wireless audio device. The user of that mobile communication device may then instruct the mobile communication device to establish a connection with the wireless audio device.

Communications between the wireless mobile communication device and the wireless audio device, whether for the purpose of the discovery process or a connection, may use various wireless communication frequencies and standards. For example, the wireless communication between the wireless mobile communication device and the audio device may use a wireless local area network (WLAN), near field communication (NFC), radio frequency identification (RFID), or radio communication (such as BLUETOOTH). A radio communication standard, such as BLUETOOTH, may use frequency hopping spread spectrum.

A content server may be any computer that can provide content to a wireless mobile communication device over a communication network. The content server may be a single computer, a cluster, or a datacenter consisting of any number of individual compute nodes, switches and supporting infrastructure. The content may be stored as data files on various types and numbers of data storage devices, and is preferably stored in association with metadata describing various aspects of individual content items. For the purpose of providing location-based content, the metadata for each individual content item may identify one or more locations that are relevant to the associated content. More specifically, where the content is an advertisement, the associated metadata may identify one or more locations where the advertisement should be targeted. If an advertisement for lawn mowers is associated with metadata identify a garage as a relevant location, then the lawn mower advertisement may be selected and provided to a wireless mobile communication device in response to identify that the wireless mobile communication device is located in a garage. As disclosed herein, the location of the wireless mobile communication device may be identified using a device name of a wireless audio device that has been discovered by the wireless mobile communication device.

The methods of the present invention may be used to identify the location of a wireless mobile communication device. In one option, the identified location may be selected from a business location, a residential location, and a vehicle. In another option, the identified location may be selected from a kitchen, garage, bathroom, laundry room and game room. The granularity of the location identification is limited only by the range over which the wireless audio devices are discovered. If multiple wireless audio device are discovered by the wireless mobile communication device, then the relative signal strengths may be used to determine which wireless audio device is the closest and the most relevant for identifying the location of the wireless mobile communication device.

In a further option of the method, the wireless mobile communication device may establish a wireless connection with the audio device. Accordingly, where the selected content includes audio content, the mobile communication device may play the audio content over the wireless audio device.

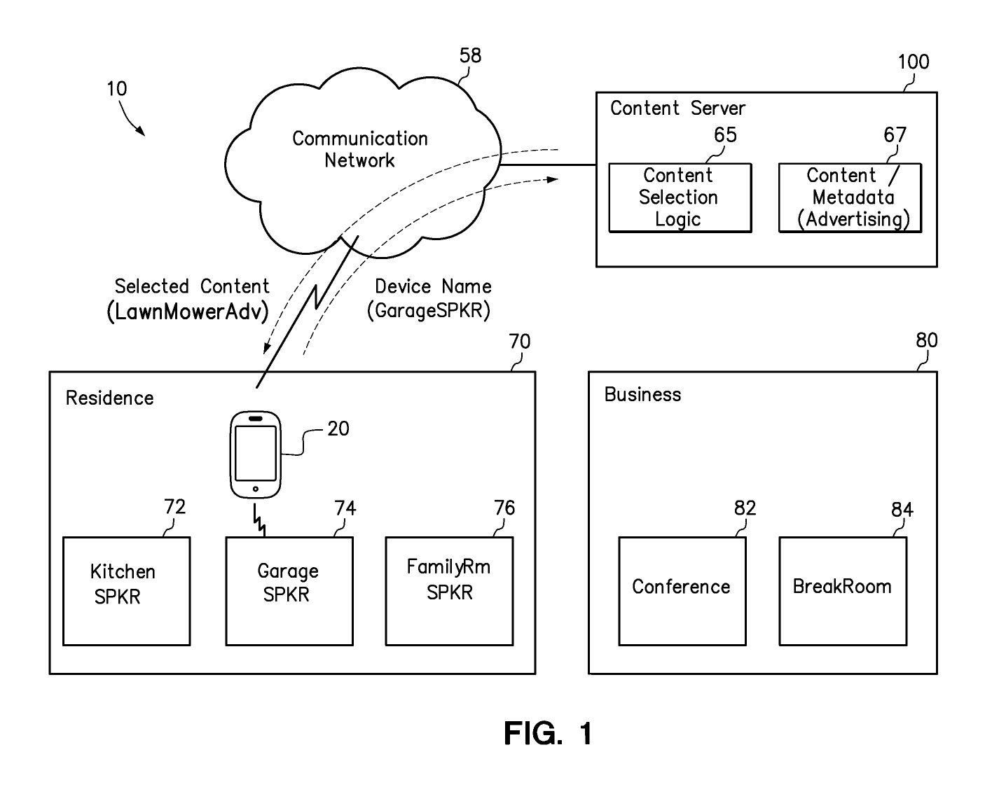

FIG. 1 is a diagram of a system 10 for providing location-based content to a wireless mobile communication device 20. In this non-limiting example, the wireless mobile communication device 20 may be located at a residence 70 or a business 80. At the business 80, the wireless mobile communication device 20 may discover a first wireless audio device 82 in a conference room or a second wireless audio device 82 in a break room. At the residence 70, the wireless mobile communication device 20 may discover a third wireless audio device 72 in a kitchen, a fourth wireless audio device 74 in a garage, or a fifth wireless audio device 76 in a family room. Each of the wireless audio devices are preferably named by a user or system administrator so that the device name indicates the location or type of location of the wireless audio device. In this example, the first wireless audio device 82 has the device name “Conference”, the second wireless audio device 82 has the device name “BreakRoom”, the third wireless audio device 72 has the device name “KitchenSPKR”, the fourth wireless audio device 74 has the device name “GarageSPKR”, and the fifth wireless audio device 76 has the device name “FamilyRmSPKR”.

As shown, the wireless mobile communication device 20 is presently located at the residence 70 and is proximate to the wireless audio device 74. Accordingly, the wireless mobile communication device 20 discovers or connects with the device 74, receives the device name “GarageSPKR”, and forwards the device name to the content server 100 via the communication network 58. The content server 100 includes content selection logic 64 to analyze the device name (“GarageSPKR”) to identify the location (“Garage”) of the user's wireless mobile communication device 20. Then, the content server 100 may use the metadata to select content from the content/metadata storage 66 that is relevant to the identified location (“Garage”) and provide the selected content (such as a lawn mower advertisement) to the wireless mobile communication device 20.

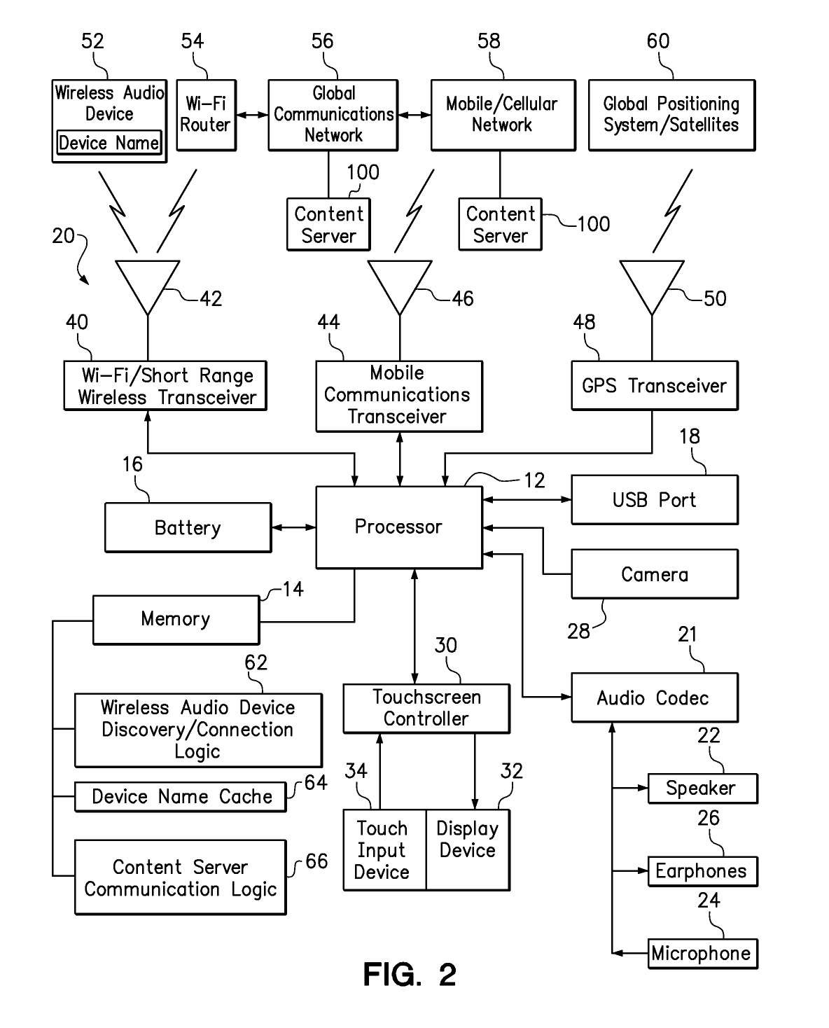

FIG. 2 is a diagram of the wireless mobile communication device 20, such as a smart phone, capable of implementing embodiments of the present invention. The communication device 20 may include a processor 12, memory 14, a battery 16, a universal serial bus (USB) port 18, a camera 28, and an audio codec 21 coupled to a speaker 22, a microphone 24, and an earphone jack 26. The communication device 10 may further include a touchscreen controller 30 which provides a graphical output to the display device 32 and an input from a touch input device 34. Collectively, the display device 32 and touch input device 34 may be referred to as a touchscreen.

The communication device 20 may also include a Wi-Fi and/or Bluetooth transceiver 40 and corresponding antenna 42 allowing the device to communicate with a wireless (Bluetooth) audio device 52 or a Wi-Fi router 54, a mobile communication transceiver 44 and corresponding antenna 46 allowing the device to communicate over a mobile/cellular network 58, and a global positioning system (GPS) transceiver 48 and corresponding antenna 50 allowing the device to obtain signals from a global positioning system or satellites 60. In a non-limiting example, the Wi-Fi router 54 and the mobile/cellular network 58 may be connected to a global communications network 56, such as the Internet. Furthermore, a content server 100 may be accessed through the mobile/cellular network 58 and/or through the global communications network 56. Two optional locations of the content server 100 are shown, but only one content server 100 is needed. As shown, the memory 14 stores a wireless audio device discover/connection logic module 62, a device name cache 64, and a content server communication logic module 66.

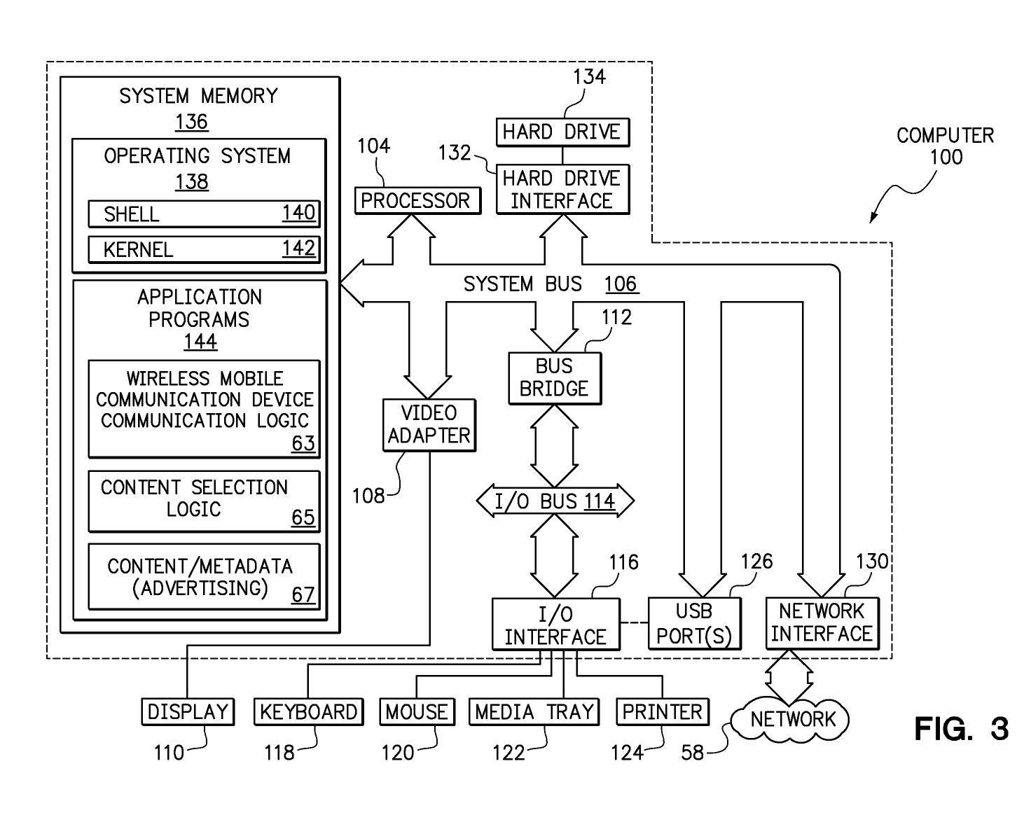

FIG. 3 is a diagram of a content server (or simply “computer”) 100 that may be utilized for providing location-based content device consistent with embodiments of the present invention. Note that some or all of the exemplary architecture, including both depicted hardware and software, shown for and within computer 100 may be implemented in the content server 100 as shown in FIGS. 1-2.

The computer 100 includes a processor unit 104 that is coupled to a system bus 106. Processor unit 104 may utilize one or more processors, each of which has one or more processor cores. A video adapter 108, which drives/supports a display 110, is also coupled to the system bus 106. The system bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and USB port(s) 126. While the format of the ports connected to I/O interface 116 may be any known to those skilled in the art of computer architecture, in a preferred embodiment some or all of these ports are universal serial bus (USB) ports. As depicted, the computer 100 is able to communicate over a network 58 using a network interface 130. The network 58 may be an external network such as the cellular network or global communication network 56, and perhaps also an internal network such as an Ethernet or a virtual private network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 100. This volatile memory includes additional higher levels of volatile memory (not shown), including, but not limited to, cache memory, registers and buffers. Data that populates system memory 136 includes computer 100's operating system (OS) 138 and application programs 144.

The operating system 138 includes a shell 140, for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while the shell 140 is a text-based, line-oriented user interface, the present invention will equally well support other user interface modes, such as graphical, voice, gestural, etc.

As depicted, the OS 138 also includes a kernel 142, which includes lower levels of functionality for the OS 138, including providing essential services required by other parts of OS 138 and application programs 144, including memory management, process and task management, disk management, and mouse and keyboard management. Application programs 144 in the system memory of computer 100 may include various programs and modules for implementing the methods described herein, such as the wireless mobile communication device communication logic module 63, content selection logic module 65, and content and metadata (advertising) 67.

The hardware elements depicted in computer 100 are not intended to be exhaustive, but rather are representative components suitable to perform the processes of the present invention. For instance, computer 100 may include alternate memory storage devices such as magnetic cassettes, digital versatile disks (DVDs), Bernoulli cartridges, and the like. These and other variations are intended to be within the spirit and scope of the present invention.

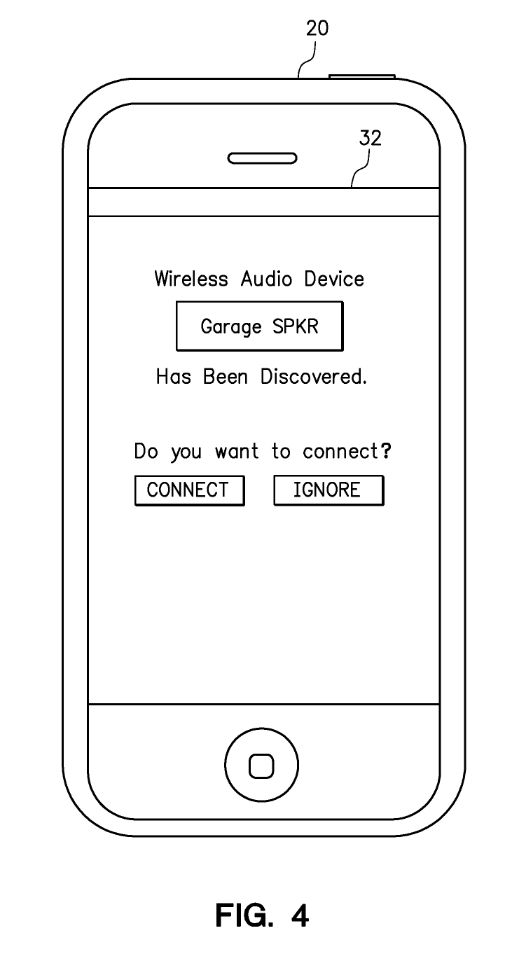

FIG. 4 is a diagram of the display screen 32 of the wireless mobile communication device 20 upon discovering the wireless audio device 74 (See FIG. 1) having the device name “GarageSPKR”. The display screen 32 displays the message “Wireless Audio Device GarageSPKR Has Been Discovered. Do you want to connect?” The display screen 32 also displays two touchscreen buttons “CONNECT” and “IGNORE” so that the user can either connect to the wireless audio device or not.

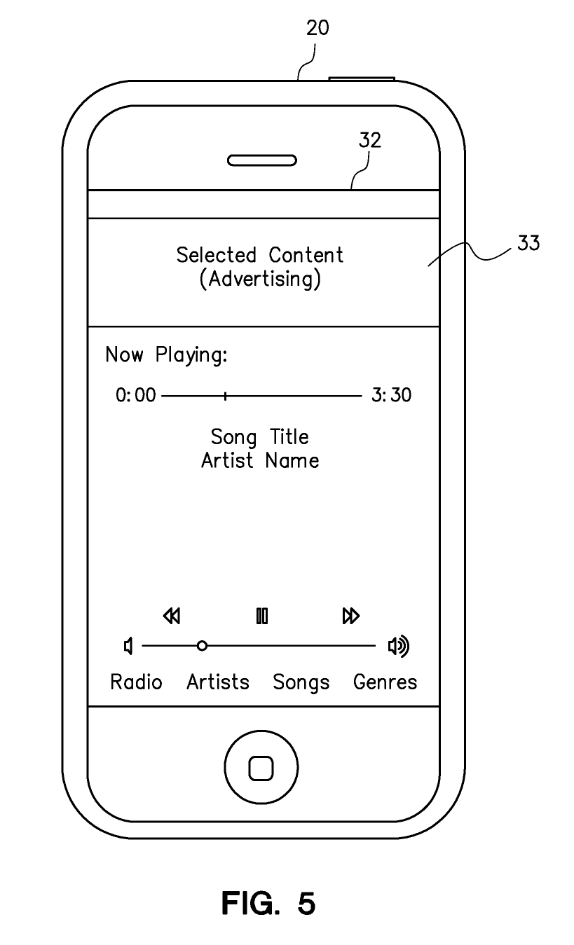

FIG. 5 is a diagram of the display screen 32 of the wireless mobile communication device 20 upon receiving and displaying selected content. While the display screen shows the functions of a music player, there is a region 33 above the music player that is displaying the selected content, such as an advertisement about lawn mowers or other garage related items.

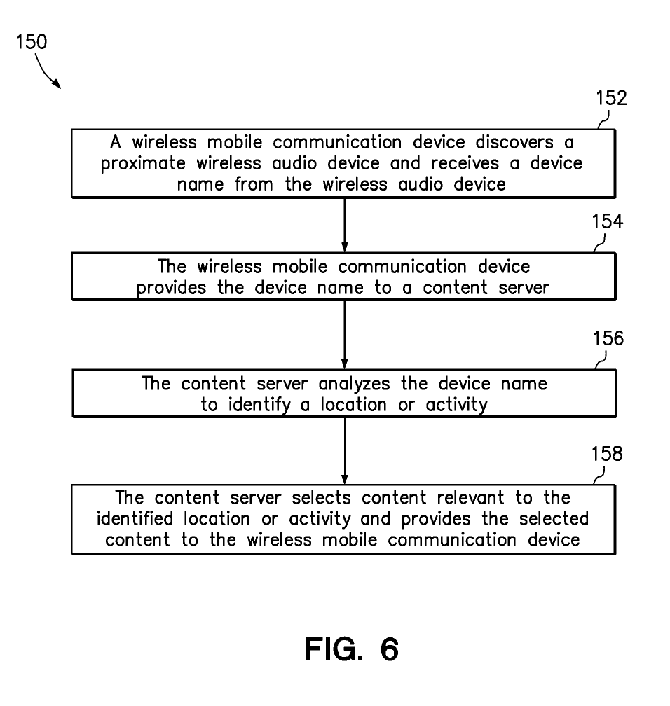

FIG. 6 is a flowchart of a method 150 according to one embodiment of the present invention. In step 152, a wireless mobile communication device discovers a proximate wireless audio device and receives a device name from the wireless audio device. In step 154, the wireless mobile communication device provides the device name to a content server. The content server analyzes the device name to identify a location or activity in step 156. The content server then selects content relevant to the identified location or activity and provides the selected content to the wireless mobile communication device in step 158.

Another embodiment of the present invention provides a computer program product comprising a computer readable storage medium having program instructions embodied therewith, wherein the program instructions are executable by a processor to cause the processor to perform a method. The method comprises a wireless mobile communication device discovering a proximate wireless audio device, receiving a device name from the wireless audio device, and providing the device name to a content server. The method further comprises the content server analyzing the device name to identify a location or activity, selecting content relevant to the identified location or activity, and providing the selected content to the wireless mobile communication device. It should be recognized that the program instructions may be divided up so that first portions of the program instructions may be executed by a first processor and second portions of the program instructions may be executed by a second processor. For example, the first processor may be part of the wireless mobile communication device and the second processor may be part of the content server.

The foregoing computer program products may further include program instructions for implementing or initiating any one or more aspects of the methods described herein. Accordingly, a separate description of the methods will not be duplicated in the context of a computer program product.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
a wireless mobile communication device discovering a proximate wireless audio device and receiving a device name from the wireless audio device; and
the wireless mobile communication device providing the device name to a content server;
the content server analyzing the device name to identify a location or activity; and
the content server selecting content relevant to the identified location or activity and providing the selected content to the wireless mobile communication device.

2. The method of claim 1, wherein the selected content is an advertisement.

3. The method of claim 1, wherein the identified location is selected from a business location, a residential location, and a vehicle.

4. The method of claim 1, wherein the identified location is selected from a kitchen, garage, bathroom, laundry room and game room.

5. The method of claim 1, further comprising:
the wireless mobile communication device establishing a wireless connection with the audio device.

6. The method of claim 5, wherein the selected content includes audio content, the further comprising:
the mobile communication device playing the audio content over the wireless audio device.

7. The method of claim 1, wherein the wireless mobile communication device discovers the audio device using radio communication.

8. The method of claim 5, wherein the wireless connection between the wireless mobile communication device and the audio device uses radio communication.

9. The method of claim 8, wherein the radio communication between the wireless mobile communication device and the audio device uses frequency hopping spread spectrum.
